(19) United States
(12) Patent Application Publication
(10) Pub. No.: US 2003/0200687 A1
(43) Pub. Date: Oct. 30, 2003

(54) Keychain assembly and method of using same

(76) Inventor: Andrew Wolfe, West Bloomfield, MI (US)

Correspondence Address: CLARK HILL, P.C., 500 WOODWARD AVENUE, SUITE 3500, DETROIT, MI, 48226, US

(21) Appl. No.: 10/132,863

(22) Filed: Apr. 25, 2002

(51) Int. Cl. G09F 15/00; G09F 3/10

(52) U.S. Cl. 40/634; 40/673

(57) ABSTRACT

A keychain assembly holds a plurality of keys thereon. The keychain assembly includes a panel that is fixedly secured to the key retainer. The panel defines a section having material printed thereon. The panel defines a predetermined thickness such that at least a portion of the material printed thereon may be removed by punching out a portion of the panel. This keychain assembly is an effective way to provide incentives to customers to have them return to a commercial entity. It provides a panel for advertisement as well as a panel of incentives. It is the incentives that keep the advertisement in the mind of the customer because the customer may not throw the keychain away if it is of value to the customer.

### BACKGROUND OF THE INVENTION

1. Field of the Invention

The invention relates to a keychain assembly. More specifically, the invention relates to a keychain assembly and method of using the keychain assembly to provide incentives to customers of a commercial entity to return to the commercial entity repeatedly.

2. Description of the Related Art

Commercial entities are often looking to maintain visibility with their customers while the customers are away from the commercial entity. Novelty items are often employed to help maintain this visibility. A list of novelty items used as promotional devices include refrigerator magnets, notepads, keychains, calendars, and the like. Many of these items lacked any motivation for keeping the novelty items from being thrown away lest a particular item is needed.

U.S. Pat. No. 6,250,556, issued to Schneider on Jun. 26, 2001, discloses a multi-purpose inventory tag device. The tag device is fabricated from a flexible sheet made of a tear resistant material. In one embodiment, the tag device includes tear away segment coupons which are used as promotional incentives. In addition, this reference sets forth that “other business logos, pictures, event name, and coding systems could be used to provide a control tag 12, key tab 18 or bracelet 28 souvenir or advertising of the event.” This system is ineffective because any tear away coupon would result in an oddly shaped fob with one or more rough edges.

### SUMMARY OF THE INVENTION

A keychain assembly holds a plurality of keys thereon. The keychain assembly includes a key retainer. The key retainer holds the plurality of keys together. The keychain assembly also includes a panel that is fixedly secured to the key retainer. The panel defines a section having material printed thereon. The panel defines a predetermined thickness such that at least a portion of the material printed thereon may be removed by punching out a portion of the panel.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is a perspective view of one embodiment of the invention; and

FIG. 2 is a top view of one embodiment of the invention.

### DETAILED DESCRIPTION OF THE PREFERRED EMBODIMENT

Referring to the Figures, the invention, a keychain assembly, is generally indicated at 10. The keychain assembly 10 is designed to hold a plurality of keys 12 thereon. The keychain assembly 10 includes a key retainer 14. The key retainer 14 is shown to be a ring. It should be appreciated by those skilled in the art that the key retainer 14 may be something other than a ring. By way of example only, the key retainer 14 may be a clasp or a hook device.

The keychain assembly 10 also includes a panel 16. The panel 16 is secured to the key retainer 14 by a link 18. The link 18 provides a limited freedom of movement for the panel 16 with respect to the key retainer 14. This helps the user of the keychain assembly 10 to store the keychain assembly 10 and the attached keys 12 in confined spaces, such as pockets or purses. More than one link 18 may be present in the keychain assembly 10.

The panel 16 is a flat piece of material. It is contemplated that the panel 16 will be fabricated from a plastic or rubber material. It should, however, be appreciated by those skilled in the art that other materials may be used when fabricating the panel 16.

The panel 16 is generally rectangular in shape. The panel 16 defines two edges 20, 22 of equal length that are less than the lengths of adjoining edges 24, 26. Because the panel 16 is rectangular, the two edges 20, 22 are of equal length and the two adjoining edges 24, 26 are of equal length. As is shown in the Figures, the panel 16 is secured to the link 18 at a position disposed adjacent one 20 of the edges 20, 22. The link 18 extends through a hole 28 in the panel 16.

The panel 16 has a thickness 30. The thickness 30 is thin enough such that it may be easily moved in and out of a standard hole punch device 32. The thickness 30 is designed to be thick enough, however, to withstand being bent or maligned through normal use. The hole punch device 32 will be discussed in greater detail subsequently.

The panel 16 defines a section 34. The section 34 of the panel 16 includes ads printed material thereon. The printed material is printed on the panel 16 in subsections 36 of the section 34. In the example shown in the Figures, the printed material relates to an oil change and lube service. The subsections 36 are distinct locations on the panel 16. The printed material may be printed on either side 38, 40 of the panel 16. If printed material is on both sides 38, 40 of the panel 16, the printed material on each side 38, 40 must be offset from each other such that punching through one side of the panel 16 does not affect the printed material on the other side. More specifically, the printed material on each side 38, 40 must be offset so that one event does not result in the punching out of two of the distinct subsections 36 of the panel 16.

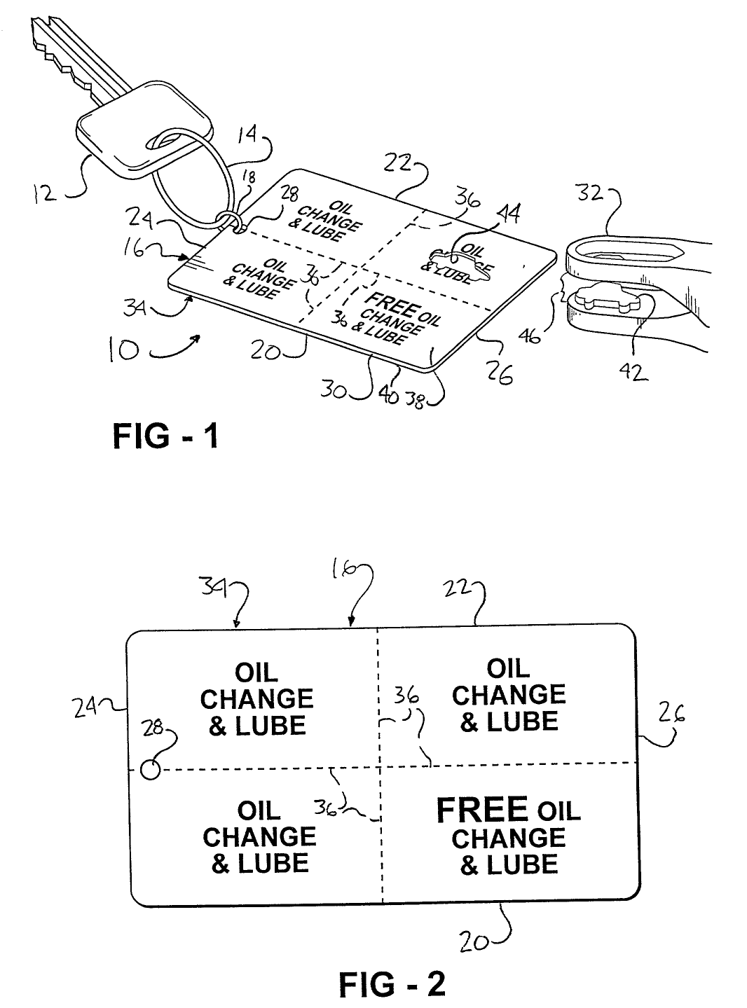

The hole punch device 32, shown partially cut away in FIG. 1, is designed similar to a standard hole punch device used to punch holes in paper. This hole punch device 32 differs in that it includes a punch out design 42 that is unique to the particular business of the entity purchasing the keychain assembly 10 for distribution. Continuing with the example of an oil change and lube as shown in the Figures, the punch out design 42 is a silhouette of a motor vehicle. The customer that receives the keychain assembly 10 returns to the commercial entity that provided the keychain assembly 10 to receive an oil change and lube service. One of the subsections 36 in FIG. 1 has been altered in that a portion 44 thereof has been punched out of the panel 16. This signifies that the customer has engaged the commercial entity a single time. The incentive for the customer to return at least three more times is indicated in the fourth subsections 36 wherein the customer receives a free oil change and lube. It should be appreciated that the services and/or incentives may vary depending on the business model of the commercial entity.

The thickness of the panel 16 is predetermined to be a thickness that is compatible with the hole punch device 32. This allows a standard hole punch device 32 to be used. Should a factor panel 16 be required, modifications to the hole punch device 32 must be made allowing the panel 16 to be inserted into an opening 46 of the hole punch device 32.

The method for providing incentives to the customers incorporates the use of the keychain assembly 10 and the hole punch device 32. The method begins when a customer engages a commercial entity. The engagement may be an actual commercial transaction or, in the alternative, it may merely be an opportunity for the customer to obtain information about the products and/or services of the commercial entity.

Once the customer contacts the commercial entity, the commercial entity provides the keychain assembly 10 to the customer. Upon the customer's return to the commercial entity, the commercial entity takes possession of the keychain assembly 10 when the customer engages the commercial entity to perform a commercial activity. At that time, the commercial entity punches out one of the plurality of subsections. The action of punching out one of the subsections 36 is in recognition of the use of that commercial entity by the customer for the commercial activity. The keychain assembly 10 is then returned to the customer. If the commercial entity desires, a new keychain assembly 10 may be offered to the customer when all of the subsections 36 of the panel 16 are punched out.

The method also includes a step of distributing a hole punch device 32 to each of the commercial entities that engaged in the method of providing incentives to customers using the keychain assembly 10. The hole punch devices 32 are distributed with a punch out design 42 that is unique to preventing any customer from purchasing a standard hole punch device 32 and fraudulently claiming to have engaged the commercial entity for activity.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A keychain assembly for holding a plurality of keys therein, said keychain assembly comprising:
a key retainer to hold the plurality of keys together; and
a panel fixedly secured to said key retainer, said panel defining a section having material printed thereon, said panel having a predetermined thickness such that at least a portion of said material printed thereon may be removed by punching out a portion of said flat.

2. A keychain assembly as set forth in claim 1 wherein said section is divided into a plurality of sub-sections such that each of said sub-sections includes said material printed thereon.

3. A keychain assembly as set forth in claim 2 wherein said panel defines a thickness less than a thickness of a paper hole punch tool.

4. A method for providing incentives to customers of an entity providing commercial activity using a keychain assembly having a panel with a plurality of sub-sections with each sub-section having writing thereon, the method including the steps of:
providing the keychain to one of the customers;
taking possession of the keychain when the customer engages the entity to perform commercial activity;
punching out one of the plurality of sub-sections to recognize the use of the entity by the customer for commercial activity; and
returning the keychain to the customer.

5. A method as set forth in claim 4 including the steps of providing a commercial incentive in the writing of each of the plurality of sections to give an incentive to the customer to return.

6. A method as set forth in claim 5 wherein the step of punching out one of the plurality of sections includes the step punching out a unique shape to identify the commercial entity as the entity engaged to provide commercial activity.

7. A method as set forth in claim 6 including the step of providing another keychain assembly to the customer when all of the plurality of sections are punched out.

8. A method as set forth in claim 7 including the step of distributing a hole punch to the commercial entity.

9. A method as set forth in claim 8 wherein the step of distributing a hole punch includes the step of making the hole punch unique in punch design.
